(19) United States
(12) Patent Application Publication
(10) Pub. No.: US 2015/0372358 A1
(43) Pub. Date: Dec. 24, 2015

(54) METAL-AIR BATTERY

(71) Applicant: SUZUKI MOTOR CORPORATION, Shizuoka-ken (JP)

(72) Inventors: Hiroaki Izumi, Shizuoka-ken (JP); Khalilur Rahman, Shizuoka-ken (JP)

(21) Appl. No.: 14/734,226

(22) Filed: Jun. 9, 2015

(30) Foreign Application Priority Data
Jun. 18, 2014 (JP) 2014-125466

(51) Int. Cl. H01M 12/08

(52) U.S. Cl. CPC H01M 12/08

(57) ABSTRACT

Problem to be Solved

The present invention reduces decrease in discharge voltage of a metal-air battery and reduces the size of the battery.

Solution

A positive electrode includes plural plate-shaped pieces of positive electrode material 32 having a porosity structure or fibrous structure and containing an electrically conductive material and the positive electrode material 32 is electrically connected with a positive electrode collector 31. Surfaces of the plural pieces of the positive electrode material 32 are coated with a catalyst, the pieces of the positive electrode material 32 are stacked with the catalyst-coated surfaces facing each other, and a direction in which the pieces of the positive electrode material 32 are stacked is arranged to be parallel to a direction in which the positive electrode and negative electrode are stacked.

### BACKGROUND OF THE INVENTION

1. Field of the Invention

The present invention relates to a metal-air battery.

2. Description of the Related Art

A metal-air battery is a device that produces electricity as an oxidation-reduction reaction proceeds. The oxidation-reduction reaction is a combination of a reduction reaction that takes place at a positive electrode (air electrode), reducing oxygen in the air, and an oxidation reaction that takes place on a negative electrode, oxidizing metal.

A lithium-air battery, which uses, for example, lithium as the metal at the negative electrode, has been under development, aiming at application in electric vehicles and the like because a lithium-air battery has a far greater energy density than a lithium ion battery. Patent Literature 1 discloses a metal-air battery comprising a positive electrode 1 in which positive electrode material layers 1a and conductive porous bodies 1b are stacked alternately, an electrolyte layer 2, and a negative electrode 3, wherein a stacking direction of the positive electrode 1 intersects a stacking direction of the positive electrode 1, the electrolyte layer 2, and the negative electrode 3.

### CITATION LIST

### Patent Literature

Patent Literature 1: Japanese Patent No. 5088378

### SUMMARY OF THE INVENTION

In order to use a lithium-air battery for electric vehicles and the like, it is necessary to increase an amount of electric current that can be drawn at one time. This is because recent vehicles use a large number of electrical system components, requiring large amounts of electric power when the vehicles start.

If the cross-sectional area of the metal-air battery is increased, the amount of electric current that can be drawn at one time increases. However, this greatly increases the mounting space necessary for the metal-air battery. The increase in the mounting space constrains the interior space and luggage compartment space when the metal-air battery is mounted in an electric vehicle.

That is, in order to increase the amount of electric current that can be drawn at one time while saving space, it is anticipated to increase the amount of electric current (mA/cm²) pcr unit area compared to the conventional level. Therefore, it is necessary to increase reaction efficiency of the oxidation-reduction reaction on the positive electrode and negative electrode.

The rate-determining reaction of the oxidation-reduction reaction in the metal-air battery is the oxygen reduction reaction on the positive electrode. Consider, for example, an oxidation-reduction reaction of a lithium-air battery in which one mol of electrons is exchanged. It is sufficient if 4 grams of Li is oxidized at the negative electrode, but approximately 5.6 liters of oxygen needs to be reduced at the positive electrode. When the amount of electric current per unit area is increased, if oxygen supply on the positive electrode does not catch up, an electric circuit does not work well, and only internal resistance increases soon, resulting in a fall in a discharge voltage. In increasing the amount of electric current per unit area, it is important to increase the efficiency (catalytic efficiency) of the oxygen reduction reaction on the positive electrode.

However, considered from the above viewpoint, the conventional example described above has problems (1) and (2) below.

(1) In the above example, the stacking direction of the positive electrode 1 intersects the stacking direction of the positive electrode 1, the electrolyte layer 2, and the negative electrode 3. This makes adhesion between the negative electrode and electrolyte layer as well as adhesion among positive electrode members nonuniform, increasing the internal resistance, and consequently, an increase in the amount of electric current soon results in a fall in the discharge voltage. As a result, the amount of electric current per unit area cannot be increased.

(2) The stacking direction of the positive electrode 1 intersects the stacking direction of the positive electrode 1, the electrolyte layer 2, and the negative electrode 3, placing the positive electrode 1 and electrolyte layer 2 in contact with each other. Consequently, when the stacking of the positive electrode is increased, the area of the electrolyte layer in contact with the positive electrode has to be increased accordingly. As a result, when the stacking of the positive electrode is increased, it is necessary to change structures of the electrolyte layer and negative electrode as well.

In the conventional example described above, experiments are conducted assuming that the current density is 0.05 mA/cm². For example, current densities such as 2 mA/cm² and 4 mA/cm² are not addressed. Thus, the above example cannot find a problem which occurs with changes in electric discharges at high current densities.

The present invention has been made to solve the above problem and has as an object to provide a metal-air battery in which discharge voltage does not fall even if an amount of electric current per unit area is increased and which allows the entire battery to be reduced in size.

To achieve the above object, in a metal-air battery according to the present invention, respective substantially flat surfaces of a positive electrode and negative electrode are stacked one on another, extending substantially perpendicularly with respect to a horizontal direction, and ions are transmitted between the positive electrode and the negative electrode through an electrolyte placed between the positive electrode and the negative electrode. In the metal-air battery, the positive electrode includes a plurality of plate-shaped pieces of positive electrode material having a porosity structure or fibrous structure and containing an electrically conductive material; the positive electrode material is electrically connected with a plate-like or linear, positive electrode collector; surfaces of the plurality of pieces of the positive electrode material are coated with a catalyst; the plurality of pieces of the positive electrode material are stacked with the catalyst-coated surfaces facing each other; and a direction in which the plurality of pieces of the positive electrode material are stacked is arranged to be parallel to a direction in which the positive electrode and negative electrode are stacked.

Also, in one aspect of the metal-air battery according to the present invention, the catalyst coats surfaces of the porous structure or the fibrous structure; and the porous structure or the fibrous structure is configured to allow air to circulate therein.

Also, in one aspect of the metal-air battery according to the present invention, from 0.19 mg/cm² to 0.75 mg/cm², both inclusive, of a mixture containing the catalyst is supported by the positive electrode material.

Also, in one aspect of the metal-air battery according to the present invention, from 0.15 mg/cm² to 0.60 mg/cm², both inclusive, of the catalyst is supported by the positive electrode material.

Also, in one aspect of the metal-air battery according to the present invention, the positive electrode material is formed of carbon paper, carbon cloth, or carbon fiber nonwoven fabric.

Also, in one aspect of the metal-air battery according to the present invention, an oxygen reaction layer is formed between adjacent pieces of the positive electrode material.

Also, in one aspect of the metal-air battery according to the present invention, the negative electrode is a complex negative polar body produced by stacking a plate-like or rod-shaped negative electrode collector, a plate-like negative electrode layer, and an isolation layer, where the negative electrode layer is made of metallic lithium, an alloy in which the principal component is lithium, or a compound in which the principal component is lithium and the isolation layer has lithium ion conductivity.

Also, in one aspect of the metal-air battery according to the present invention, the complex negative polar body includes a plate-like or rod-shaped negative electrode collector, two negative electrode layers made of metallic lithium, an alloy of which principal component is lithium, or a compound of which principal component is lithium and formed into plate shapes so as to sandwich part of the negative electrode collector, two isolation layers provided with lithium ion conductivity and formed into plate shapes so as to entirely sandwich the two negative electrode layers, and a joining portion adapted to join and close outer peripheral portions of the two isolation layers. The positive electrode material is electrically connected to the positive electrode collector, facing at least one of the two isolation layers.

Also, in one aspect of the metal-air battery according to the present invention, the negative electrode complex and positive electrode material are stacked alternately and electrically connected in parallel.

Also, in one aspect of the metal-air battery according to the present invention, the positive electrode material is bent in a zigzag pattern and a plurality of negative electrode complexes are sandwiched by planar portions provided between folds of the positive electrode material.

Also, according to one aspect, the metal-air battery according to the present invention comprises a gasket placed between the two isolation layers, surrounding the two negative electrode layers, and adapted to seal a space between the two isolation layers.

According to the present invention, the positive electrode is formed by stacking a plurality of plate-shaped pieces of positive electrode material and the direction in which the positive electrode and negative electrode is stacked is parallel to the stacking direction of the positive electrode material. This increases adhesion among the members and reduces internal resistance. This prevents the discharge voltage from falling even when the amount of electric current is increased and allows the amount of electric current per unit area to be increased.

Also, to increase the stacking of the positive electrode material, it only remains to stack more pieces of positive electrode material, and thus even when the stacking of the positive electrode material is increased, there is no need to change the structure of any part other than the positive electrode. This makes it possible to improve the oxygen reducing ability of the positive electrode easily.

Also, according to one aspect of the present invention, the fibrous structure or porous structure of the positive electrode material has its surfaces coated with a catalyst and includes space in which air can circulate, allowing oxygen to permeate freely through gaps in fibers or porosity. This improves the reducing ability of the catalyst, making it possible to increase the amount of electric current per unit area. Also, even if plural pieces of positive electrode material are stacked, since oxygen can pass freely among the stacked positive electrodes, oxygen spreads sufficiently even into the positive electrode material stacked on an inner side, making it possible to restrain degradation in the reducing ability of the catalyst on the inner side. Consequently, it becomes possible to increase the amount of electric current per unit area.

Also, according to one aspect of the present invention, the catalyst may be not only a metal catalyst, but also a mixture containing a binder. Also, from 0.19 mg/cm² to 0.75 mg/cm² (both inclusive) of the mixture is supported by the positive electrode material. This makes it possible to avoid a situation in which a certain catalyst does not contribute to the reduction reaction by being hidden by another catalyst or the binder. As a result, all the supported catalysts can be utilized. Note that even if 0.75 mg/cm² or more of the mixture is supported, this is not effective because some part of the catalysts cannot contribute to the reaction.

Also, the gaps (porous part) in the fibers on the surfaces of the positive electrode material are not hidden, and oxygen permeates freely therethrough. This inhibits the supported mixture from blocking the circulation of oxygen, prevents the reducing ability of the catalyst from becoming deficient even if the amount of electric current per unit area is large, and thereby prevents the discharge voltage from falling.

Also, according to one aspect of the present invention, from 0.15 mg/cm² to 0.60 mg/cm² (both inclusive) of the catalyst is supported by the positive electrode material. This allows the fibers on the surfaces of the positive electrode material to be coated with a sufficient amount of catalyst. Consequently, even if the amount of electric current per unit area is increased, the oxygen reducing ability of the catalyst does not become deficient, which makes it possible to prevent the discharge voltage from falling.

Also, according to one aspect of the present invention, the positive electrode material is formed of a carbon material such as carbon paper, carbon cloth or carbon fiber nonwoven fabric. Carbon materials are highly resistant to corrosion, light in weight, and highly gas-diffusible and electroconductive. This makes it possible to maintain oxygen permeability and electrical conductivity.

Also, according to one aspect of the present invention, an oxygen reaction layer (filled with air spaces or an electrolyte) is formed between adjacent pieces of the positive electrode material. This improves air permeability among pieces of the positive electrode material and improves oxygen permeability in the positive electrode material. This improves the reducing ability of the catalyst, making it possible to increase the amount of electric current per unit area.

The negative electrode layer is made of metallic lithium. Although theoretical energy density is very high and the negative electrode layer is compact, if one attempts to draw a lot of energy per unit time (increase the amount of electric current per unit area), the oxygen reducing ability of the positive electrode will be insufficient. In contrast, when the negative electrode layer is combined with the positive electrode as with this aspect of the present invention, even if a lot of energy is drawn per unit time, deficiency in the oxygen reducing ability of the positive electrode can be mitigated. This appears prominently especially when the amount of electric current per unit area is large. This makes it possible to reduce the size of the battery and increase the amount of electric current per unit area.

Also, one aspect of the present invention provides a compact lithium-air battery which can avoid extreme increase in size even if energy density and input-output density are increased. Also, the metal-air battery combined with the positive electrode according to the aspect is more compact, high in energy density, and superior in discharge characteristics.

Also, according to one aspect of the present invention, cells each made up of a composite negative electrode and a positive electrode are encased, connected in parallel, and modularized. Consequently, an electrolytic solution can be shared among cells, eliminating the need to partition the electrolytic solution on a cell-by-cell basis. This improves energy density, making it possible to simplify the structure.

Also, according to an aspect of the present invention, only a single air electrode collector can be provided for one air electrode layer which sandwiches plural negative electrode complexes, making it possible to reduce quantity, total length, length, and volume.

Also, according to an aspect of the present invention, by pressing one or both of the isolation layers directly or indirectly, it is possible to improve overall adhesion between the contact surfaces of a buffer layer and the isolation layers. Furthermore, contact between the isolation layers and negative electrode layers via the buffer layers can be increased. This reduces internal resistance and thereby increases discharge voltage.

### BRIEF DESCRIPTION OF THE DRAWINGS

FIG. 1 is a schematic cross-sectional view schematically showing a metal-air battery according to the present invention;

FIG. 2 is a graph showing a discharge voltage versus an amount of catalyst used to coat positive electrode material;

FIG. 3 is a perspective view showing an example of modularized cells made up of complex negative polar bodies and positive electrode material of the metal-air battery shown in FIG. 1;

FIG. 4 is an exploded perspective view of the complex negative polar body of FIG. 3;

FIG. 5 is a sectional view of the complex negative electrode portion of FIG. 4 as assembled;

FIGS. 6A and 6B are graphs showing discharge characteristics in the positive electrode structure of FIG. 1, where FIG. 6A shows a discharge voltage when the number of pieces of the positive electrode material is one, three, or four and current density is 0.5 mA/cm² while FIG. 6B shows a discharge voltage when the number of pieces of the positive electrode material is one, three, or four and current density is 2 mA/cm²; and

FIG. 7 is a schematic perspective view showing a variation of the metal-air battery of FIG. 3.

### DETAILED DESCRIPTION OF THE PREFERRED EMBODIMENTS

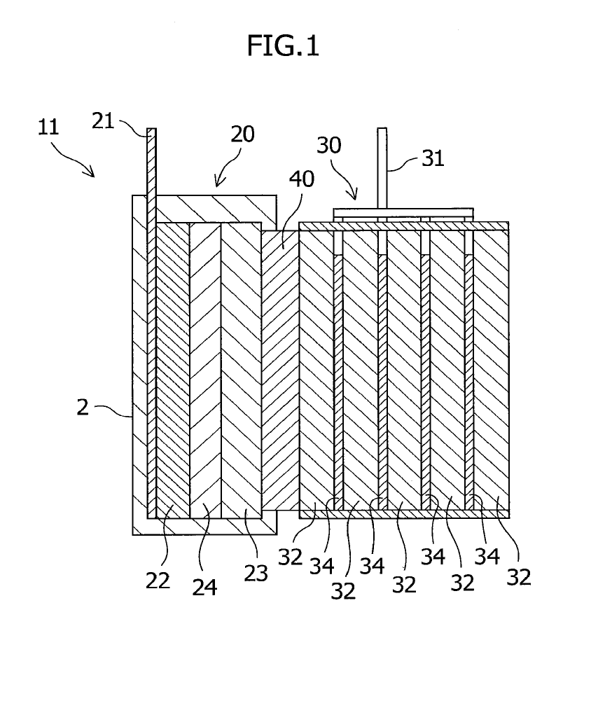

An embodiment of a metal-air battery according to the present invention will be described below with reference to the accompanying drawings (FIG. 1 to FIG. 6). In the metal-air battery, ions are transmitted between a positive electrode and negative electrode through an electrolyte 40 placed between the positive electrode and negative electrode.

A configuration of the metal-air battery according to the present embodiment will be described below. First, a configuration of a cell (air battery cell 11) of the metal-air battery will be described with reference to FIG. 1. As shown in FIG. 1, the air battery cell 11 includes a positive electrode structure 30 serving as the positive electrode, and it includes a negative electrode (negative electrode complex 20). The positive electrode structure 30 and negative electrode complex 20 are stacked via the electrolyte 40. The electrolyte 40 is interposed between the positive electrode structure 30 and negative electrode complex 20, for example, by being drawn from a tank or the like under the positive electrode structure 30 or the like.

Respective substantially flat surfaces of the positive electrode and negative electrode are stacked one on the other, extending substantially perpendicularly (up-and-down direction in FIG. 1) with respect to a horizontal direction. A direction (right-and-left direction in FIG. 1) in which plural pieces of positive electrode material 32 (described later) are stacked is arranged to be parallel to a direction (right-and-left direction in FIG. 1) in which the positive electrode and negative electrode are stacked. Also, an oxygen reaction layer 34 is formed between each pair of adjacent pieces of the positive electrode material 32. The oxygen reaction layer 34 is a space between pieces of the positive electrode material 32 and has a thickness (length in the right-and-left direction in FIG. 1) which is determined by taking increases in the internal resistance into consideration and which may be somewhere around a few hundred microns at the maximum According to the present embodiment, the metal-air battery 1 is constructed by stacking plural metal-air battery cells 11 (FIG. 3). In the metal-air battery 1, the negative electrode complexes 20 each housed in a case 2 and the positive electrode structure 30 are stacked alternately and electrically connected in parallel.

Components making up the cell of the metal-air battery will be described below. First, the positive electrode (positive electrode structure 30) will be described.

As shown in FIG. 1, the positive electrode structure 30, which serves as the positive electrode of the metal-air battery cell 11, includes plural pieces of positive electrode material 32. Each of the plural pieces of the positive electrode material 32 is formed into a rectangular plate shape and has a porous structure or fibrous structure. Also, the positive electrode material 32 contains electroconductive material. Note that although the positive electrode material 32 is formed into a plate shape in FIG. 1, actually, the positive electrode material 32 has a thin-plate shape made of an electroconductive material such as carbon fibers.

Possible structures of the positive electrode material 32 includes a porous structure, a mesh structure in which fibers are arranged regularly, a nonwoven fabric structure in which fibers are arranged at random, and three-dimensional network structure. Specifically, the positive electrode material 32 is faulted of a carbon material such as carbon cloth, carbon fiber nonwoven fabric, or carbon paper.

Note that another material having a porous structure may be used, examples of which include metal materials such as stainless steel, nickel, aluminum, and iron. Preferably, the positive electrode material 32 is formed of the above-mentioned carbon material, which is highly resistant to corrosion, light in weight, and highly gas-diffusible and electroconductive. The positive electrode material 32 may contain a catalyst such as a noble metal or metal oxide. The catalyst will be described later.

The positive electrode material 32 is electrically connected with a plate-like or linear, positive electrode collector 31. It is sufficient if the positive electrode collector 31 can exist stably in an operating range of the metal-air battery and has desired electrical conductivity.

The positive electrode collector 31 is formed, for example, of a metallic material such as stainless steel, nickel, aluminum, gold, or platinum, or a carbon material such as carbon cloth or carbon fiber nonwoven fabric. A material which has high corrosion resistance and high electrical conductivity is more preferable.

Surfaces of the plural pieces of the positive electrode material 32 are coated with a catalyst and the plural pieces of the positive electrode material 32 are stacked with the catalyst-coated surfaces facing each other. Now, the catalyst will be described. The positive electrode material 32 contains, as required, an electroconductive material, catalyst such as a noble metal and/or metal oxide, or a binder which binds these.

Examples of the electroconductive material include carbon materials with a high specific surface area, such as carbon black and active carbon.

Any catalyst can be used as long as the catalyst facilitates an oxygen reduction reaction during discharge and facilitates an oxygen oxidation reaction during charging. Examples of available materials include metal oxides such as MnO₂, CeO₂, CO₃O₄, NiO, V₂O₅, Fe₂O₃, ZnO, CuO, La_{1.6}Sr_{0.4}NiO₄, La₂NiO₄, La_{0.6}Sr_{0.4}FeO₃, La_{0.6} Sr_{0.4} Co_{0.2}Fe_{0.8}O₃, La_{0.8}Sr_{0.2}MnO₃, Mn_{1.5}Co_{1.5}O₄; noble metals such as Au, Pt, the Ag; and compounds thereof.

The positive electrode material 32 containing a catalyst is produced, for example, by attaching a slurry prepared by mixing carbon which supports a catalytic metal such as Pt (platinum) with a binder and organic solvent and attaching the slurry to carbon cloth.

Examples of materials available for use as the binder mixed with carbon include polyvinylidene fluoride (PVDF), a Nafion-(R) dispersed solution, polytetra-fluoroethylene (PTFE), styrene butadiene rubber (SBR), and the like, and a polymeric material typically used for electrodes of lithium ion batteries. Also, examples of materials available for use as the organic solvent mixed with carbon include n-methyl pyrrolidone (NMP), acetonitrile, dimethyl formamide (DMF), dimethyl acetamide (DMA), and dimethyl sulfoxide (DMSO).

Regarding a method for applying the catalyst to the positive electrode material 32, a slurry such as described above is applied and adhered by a doctor blade method, dip coating method, or spray method.

The catalyst coats surfaces of a porous structure or fibrous structure. The porous structure or fibrous structure is configured to allow air to circulate therein.

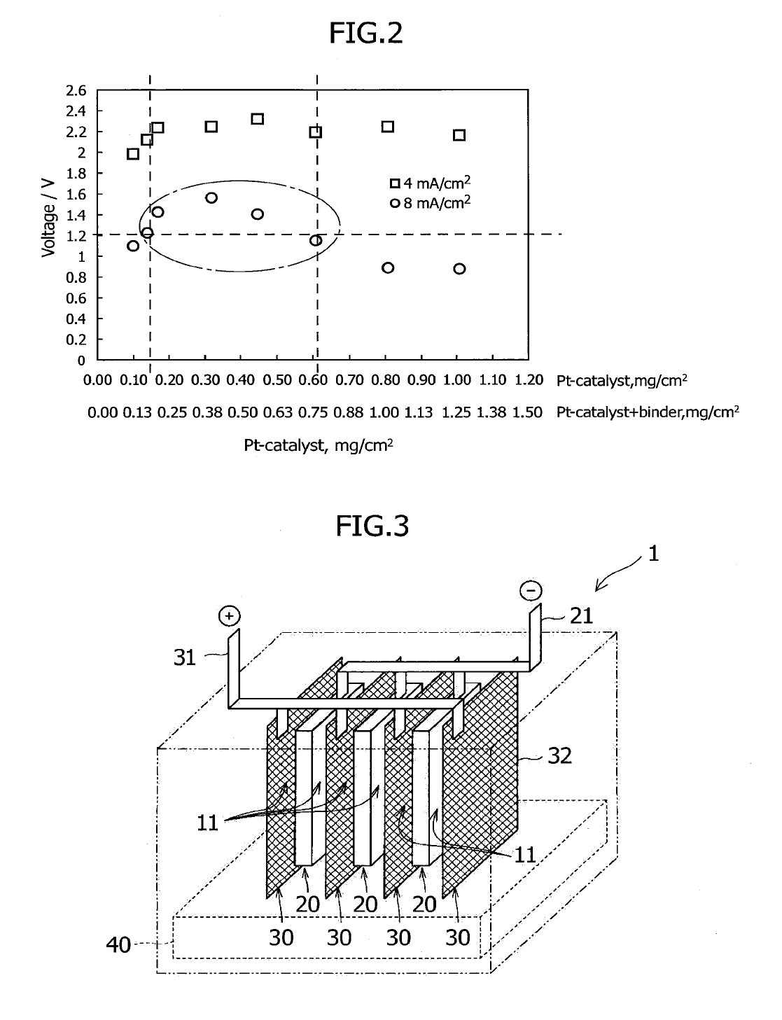

The numerical values written in the upper row along the abscissa of the graph shown in FIG. 2 indicate amounts of catalyst when no binder is contained. The lower row along the abscissa of the graph indicates amounts of a mixture made up of the catalyst containing a binder. The ordinate represents a discharge voltage. Also, square plot symbols represent voltage values at a current density of 4 mA/cm² and circular plot symbols represent voltage values at a current density of 8 mA/cm².

Here, in practical use, the discharge voltage of the metal-air battery needs to be at least around 1.2 V. The amount of catalyst and the like which provide a discharge voltage of 1.2 V or more are in the following ranges.

The mixture made up of the catalyst containing a binder needs to be supported by the positive electrode material 32 such that from 0.19 mg/cm² to 0.75 mg/cm² (both inclusive) of the mixture will be supported by the positive electrode material as shown in FIG. 2. Regarding the catalyst containing no binder, the catalyst needs to be supported by the positive electrode material 32 so as to range between 0.15 mg/cm² and 0.60 mg/cm², both inclusive.

Next, the negative electrode will be described.

The negative electrode includes a negative electrode collector 21 and a complex negative polar body as shown in FIG. 1. The negative electrode collector 21 is shaped like a plate or rod as shown in FIGS. 1, 3, and the like. In this example, the negative electrode collector 21 is shaped like a plate.

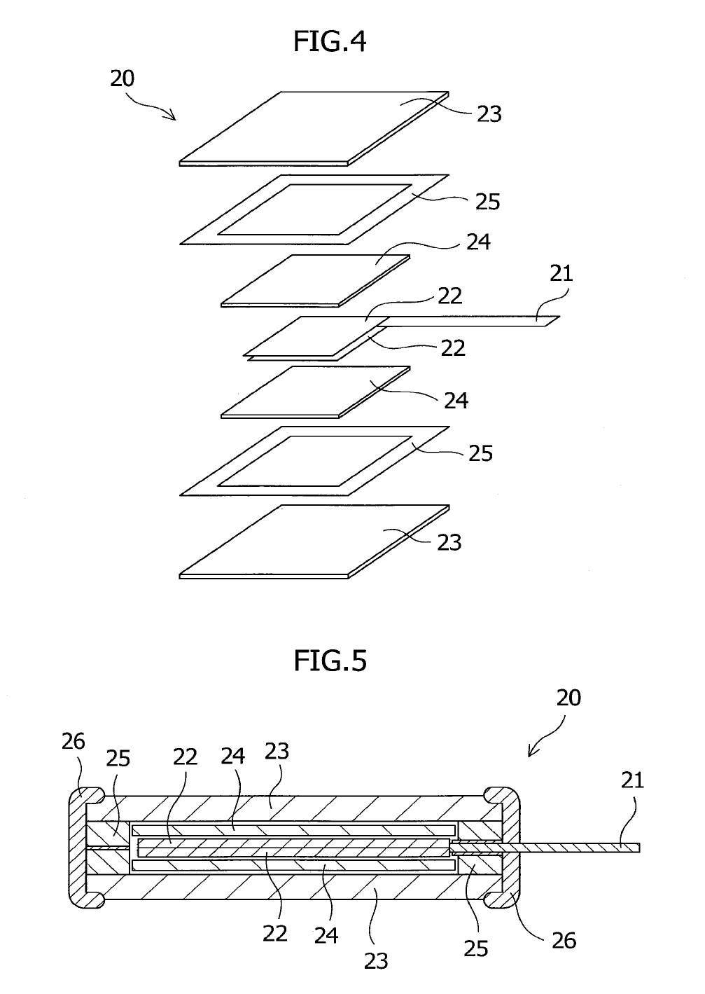

As shown in FIGS. 4 and 5, the complex negative polar body includes the negative electrode collector 21, two negative electrode layers 22, two buffer layers (separators) 24, two gasket sheets 25, two isolation layers (solid electrolyte) 23, and a joining portion 26.

The two negative electrode layers 22 are formed into plate shapes so as to sandwich part of the negative electrode collector 21 and are made of metallic lithium, an alloy of which the principal component is lithium, or a compound of which the principal component is lithium. The negative electrode collectors 21 achieve their effects as charge collectors as long as they have a length appropriate to be sandwiched between the two negative electrode layers 22.

The two buffer layers (separators) 24 are sheet-Eke members configured to sandwich the two negative electrode layers 22 therebetween. The two gasket sheets 25 are placed between the two isolation layers 23, surrounding the two negative electrode layers 22, and adapted to seal a space between the two isolation layers 23. In this example, the gasket sheets 25 are quadrangular frame-like members configured to sandwich the two separators.

The two isolation layers (solid electrolyte) 23 are a solid electrolyte placed outside the two buffer layers 24, formed into plate shapes which entirely sandwich the two negative electrode layers 22, and provided with lithium ion conductivity. Metallic lithium and the like in the negative electrode layers 22 (described later) react upon contact with oxygen in water or in the air. Consequently, the negative electrode layers 22 are protected by being sandwiched by the two pieces of solid electrolyte. Also, the positive electrode material 32 is placed so as to face at least one of the two isolation layers 23.

The negative electrode complex 20 is configured to sandwich the two negative electrode layers 22 between the two pieces of solid electrolyte. The negative electrode complex 20 does not need to pack the negative electrode layers 22 in a packing material such as an aluminum laminate, and is structured to stack the positive electrode material 32 and negative electrode complex 20 easily as a single cell.

The joining portion 26 is formed so as to join and close outer peripheral portions of the two isolation layers 23. The joining portion 26 in this example is provided on both right and left sides of the solid electrolyte and the like in FIG. 5. Components of the negative electrode complex 20 will be described below in detail.

(Buffer layer) In this example, LTAP is used as the solid electrolyte (described later). LTAP has water resistance depending on how it has been synthesized and processed, but is inferior in resistance to metallic lithium and deteriorates when placed in direct contact with metallic lithium. Therefore, the buffer layers 24 are provided between the negative electrode layers 22 and solid electrolyte 23. The buffer layers 24 are prepared by impregnating separators for a lithium ion battery with an organic electrolytic solution. The buffer layers 24 are placed between metallic lithium (negative electrode layers 22) and LTAP having insufficient resistance to metallic lithium by giving consideration to ionic conductivity of the solid electrolyte and negative electrode layers 22.

The buffer layers 24 may be sheet-like layers or gelatinous layers which protect the solid electrolyte 23 and have ionic conductivity. For example, the buffer layers 24 may be made of a gelatinous polymer electrolyte prepared by dissolving a lithium salt in an organic electrolytic solution and causing a polymer to swell in the organic electrolytic solution.

Available polymers include PEO (polyethylene oxide) and PPO (polypropylene oxide). Examples of polymers which can act as a host of the gel electrolyte include PEO (polyethylene oxide), PVA (polyvinyl alcohol), PAN (polyacrylonitrile), PVP (polyvinyl pyrrolidone), PEO-PMA (cross-linked poly(ethylene oxide)-modified polymethacrylate), PVdF (polyvinylidene fluoride), PVA (polyvinyl alcohol), PAA (polyacrylic acid), PVdF-HFP (copolymer of polyvinylidene fluoride and hexafluoropropylene). Examples of lithium salts include LiPF₆, LiClO₄, LiBF₄, LiTFSI(Li(CF₃SO₂)₂N), Li(C₂F₄SO₂)₂N, LiBOB (lithium bis(oxalate)borate).

Note that: when PEO, which is particularly desirable, is used as the polymer for the buffer layers 24, desirably the molecular weight of PEO is 10⁴ to 10⁵ and desirably the mole ratio between PEO and lithium salt is from 8:1 to 30:1.

To improve strength and electrochemical properties of the buffer layers 24, a ceramic filler such as powder of BaTiO₃ may be further dispersed in the polymer. Desirably a mixing amount of the ceramic filler is 1 to 20 parts by weight to 100 parts by weight of the remaining constituents.

### Separator

The separator is a member used to prevent contact between active materials of the positive electrode and negative electrode. The separator is made of a porous material, such as cellulose, nonwoven chemical fiber fabric, or a polymer membrane of a PP (polypropylene) resin, PE (polyethylene) resin, or PI (polyimide) resin, readily impregnated with the electrolyte.

### Organic Electrolytic Solution

The organic electrolytic solution is made of a mixed solvent of PC (propylene carbonate), EC (ethylene carbonate), DMC (dimethyl carbonate), EMC (ethyl methyl carbonate), and the like and often laced with an electrolyte such as LiPF₆ (lithium hexafluoroborate), LiClO₄ (lithium perchlorate), or LiBF₄ (lithium tetrafluoroborate).

### Negative Electrode Layer

The negative electrode layers 22 according to the present embodiment arc made of metallic lithium pasted on opposite surfaces of copper foil of the negative electrode collector 21 and thickness and area of the negative electrode layers 22 may sometimes be changed depending on battery capacity.

Desirably the negative electrode layers 22 are made of metallic lithium, but an alloy of which the principal component is lithium, or a compound of which the principal component is lithium may be used instead of metallic lithium.

The alloy of which the principal component is lithium can contain magnesium, calcium, aluminum, silicon, germanium, tin, lead, arsenic, antimony, bismuth, silver, gold, zinc, and the like. Examples of the alloy of which the principal component is lithium include Li₃₋ₓMₓN (M=Co, Cu, Ni).

### Negative Electrode Collector

It is sufficient for the negative electrode collectors 21 to exist stably in an operating range of metal-air battery and has desired electrical conductivity. Examples of available materials include copper and nickel.

### Isolation Layer: Solid Electrolyte

The isolation layers (solid electrolyte) 23 in the present example is made of glass-ceramics having lithium ion conductivity. Since the isolation layers 23 belong to the negative electrode complex 20, desirably, the isolation layers 23 have resistance to water and desirably their lithium ion conductivity are 10⁻⁵ S/cm or above. The solid electrolyte may be, for example, a lithium ion conductor of a NASICON (Na super ionic conductor) type.

Examples of available materials include a lithium ion conductor which is expressed by a general formula Li₁₊ₓM₂-xM′ₓ(PO₄)₃ and in which the lithium ion conductivity has been improved by substituting part of a tetravalent cation M of a lithium ion conductor expressed by a general formula LiM₂(PO₄)₃ (M is a tetravalent cation of Zr, Ti, Ge, or the like) with a trivalent cation M of In, Al, or the like.

Also, the examples include a lithium ion conductor which is expressed by a general formula Li₁₋ₓM₂₋ₓM″ₓ(PO₄)₃ and of which the lithium ion conductivity has been improved by substituting part of a tetravalent cation M of a lithium ion conductor expressed by the general formula LiM₂(PO₄)₃ (M is a tetravalent cation of Zr, Ti, Ge, or the like) with a pentavalent cation M″ of Ta, or the like.

P in these lithium ion conductors may have been substituted with Si, and a lithium ion conductor expressed by a general formula Li_{1+x+y}Ti₂₋ₓAlₓP_{3-y}Si_{y}O₁₂ (LTAP) is desirable from the viewpoint of ion conductivity. In this case, the lithium ion conductor is superior in lithium ion conductivity, incombustibility, water resistance, and long-term stability, and reliably protects the negative electrode layers 22 from water.

### Gasket Sheet

The gasket sheets 25 are formed of ethylene propylene rubber (EPDM). Note that the material of the gasket sheets 25 is not limited to EPDM as long as the material is a rubber elastomer resistant to the organic electrolytic solution described above. The installation of the gasket sheets 25 makes it possible to improve internal sealability as well as adhesion between the metallic lithium and the solid electrolyte.

Available methods for fixing the gasket sheets 25 from outside the negative electrode complex 20 include the use of an adhesive. To bond and fix together cross sections of the solid electrolyte (ceramic electrolyte), an adhesive which can bond together the solid electrolyte is used. Examples of available adhesives include epoxy adhesives, acrylic adhesives, and synthetic rubber adhesives.

Preferably the adhesive has low moisture permeability, high sealability, and resistance to aqueous electrolytic solution (and preferably to organic electrolytic solutions as well). In the present example, a two-part, cold-setting epoxy adhesive 26 is used.

Also, the fixing method described above is not limited to the one which uses an adhesive, and a pressing method which involves applying pressure from outside by means of something like a clip may be used as well.

Also, the gasket sheet 25 is not particularly limited as long as the gasket sheet 25 is made of rubber or elastomer resistant to organic electrolytes. Rubber or elastomer produced by ethylene-propylene-diene copolymerization or fluorinated rubber or elastomer is preferable. Examples of the rubber produced by ethylene-propylene-diene copolymerization include EPM, EPDM, and EPT.

Examples of the fluorinated rubber or elastomer include vinylidene fluoride (FKM) rubbers or elastomers, tetrafluoroethylene-propylene (FEPM) rubbers or elastomers, and tetrafluoroethylene-perfluorovinyl ether (FFKM) rubbers or elastomers. Regarding physical properties, preferably the rubber or elastomer has low hardness.

Preferably the material for the gasket sheets 25 has a hardness of around 50 to 70 Shore A. A significantly soft material for the gasket sheets 25 presents a problem such as poor workability during assembly.

When the gasket sheets 25 have predetermined degrees of hardness and rubber elasticity, heights of components in the negative electrode complex 20 can be adjusted uniformly. Also, preferably the raw material for the rubber or elastomer before molding is a liquid type and has high absorbency or adhesiveness.

As can be seen from the above description, according to the present embodiment, the positive electrode is formed by stacking a plurality of plate-shaped pieces of positive electrode material 32, and the direction in which the positive electrode and negative electrode are stacked is configured to be parallel to the stacking direction of the positive electrode material 32. This configuration increases adhesion among the members and reduces internal resistance. This prevents the discharge voltage from falling even when the amount of electric current is increased and allows the amount of electric current per unit area to be increased.

Also, to increase the stacking of the positive electrode material 32, it only remains to stack more pieces of the positive electrode material 32, and thus, even when the stacking of the positive electrode material 32 is increased, there is no need to change the structure of any part other than the positive electrode. This makes it possible to improve the oxygen reducing ability of the positive electrode easily. Furthermore, the present embodiment provides the following advantages.

The fibrous structure or porous structure of the positive electrode material 32 has its surfaces coated with a catalyst and includes space in which air can circulate, allowing oxygen to permeate freely through gaps in fibers or porosity. This improves the reducing ability of the catalyst, making it possible to increase the amount of electric current per unit area. Also, even if plural pieces of the positive electrode material 32 are stacked, since oxygen can pass freely among the stacked pieces of the positive electrode material 32, oxygen spreads sufficiently even into the positive electrode material 32 stacked on an inner side, making it possible to restrain degradation in the reducing ability of the catalyst on the inner side. Consequently, it becomes possible to increase the amount of electric current per unit area.

The catalyst may be not only, for example, a metal catalyst, but also a mixture containing a binder. From 0.19 m g/cm² to 0.75 mg/cm² (both inclusive) of the mixture is supported by the positive electrode material 32.

This makes it possible to avoid a situation in which a catalyst becomes less dispersed and blocked by another catalyst or the binder, thereby ceasing to contribute to the reduction reaction. As a result, all the supported catalysts can be utilized. Note that even if 0.75 mg/cm² or more of the mixture is supported, this is not effective because some part of the catalysts cannot contribute to the reaction.

Also, the gaps (porous part) in the fibers on the surfaces of the positive electrode material 32 are not blocked, and oxygen permeates freely therethrough. This inhibits the supported mixture from blocking the circulation of oxygen, prevents the reducing ability of the catalyst from becoming deficient even if the amount of electric current per unit area is large, and thereby prevents the discharge voltage from falling.

Also, from 0.15 mg/cm² to 0.60 mg/cm² (both inclusive) of the catalyst is supported by the positive electrode material 32. This allows the fibers on the surfaces of the positive electrode material 32 to be coated with preferable amount of catalyst. Consequently, even if the amount of electric current per unit area is increased, the oxygen reducing ability of the catalyst does not become deficient, which makes it possible to prevent the discharge voltage from falling.

The positive electrode material 32 is formed of a carbon material such as carbon paper, carbon cloth or carbon fiber nonwoven fabric. Carbon materials are highly resistant to corrosion, light in weight, and highly gas-diffusible and electroconductive. This makes it possible to maintain oxygen permeability and electrical conductivity.

The oxygen reaction layer 34 filled with air spaces or the electrolyte 40 is formed between adjacent pieces of the positive electrode material 32. This improves air permeability among pieces of the positive electrode material 32 and improves oxygen permeability in the positive electrode material 32. This improves the reducing ability of the catalyst, making it possible to increase the amount of electric current per unit area.

The negative electrode layers 22 are made of metallic lithium. Although theoretical energy density is very high and the negative electrode layer is compact, if one attempts to draw a lot of energy per unit time (increase the amount of electric current per unit area), the oxygen reducing ability of the positive electrode becomes deficient. In contrast, according to the present embodiment, when the negative electrode layer is combined with the positive electrode material 32, even if a lot of energy is drawn per unit time, deficiency in the oxygen reducing ability of the positive electrode can be mitigated. This appears prominently especially when the amount of electric current per unit area is large. This makes it possible to reduce the size of the battery and increase the amount of electric current per unit area.

Also, the present embodiment provides a compact lithium-air battery which can avoid extreme increase in size even if energy density and input-output density are increased. Also, the metal-air battery combined with the positive electrode according to the present embodiment is more compact, high in energy density, and superior in discharge characteristics.

According to the present embodiment, the negative electrode complex 20 and positive electrode material 32 are stacked alternately and electrically connected in parallel. In this way, as the cells each made up of the complex negative polar body and positive electrode material 32 are encased, connected in parallel, and modularized, the electrolytic solution can be shared among cells, eliminating the need to partition the electrolytic solution on a cell-by-cell basis. This improves energy density, making it possible to simplify the structure.

Also, according to the present embodiment, since the gasket sheets 25 are installed, by pressing one or both of the isolation layers 23 directly or indirectly, it is possible to improve overall adhesion between the contact surfaces of the buffer layers 24 and the isolation layers 23. Furthermore, contact between the isolation layers 23 and negative electrode layers 22 via the buffer layers 24 can be increased. This reduces internal resistance and thereby increases discharge voltage.

Now, an example of procedures for creating the negative electrode complex 20 according to the present embodiment will be described.

In this example, the negative electrode complex 20 (FIG. 4 and FIG. 5) is created using procedures (1) to (4) below in an Ar gas atmosphere with an oxygen concentration of 1 ppm or less and a dew point of −76° C.dp.

(1) The solid electrolyte 23 in the isolation layers, metallic lithium 22 of the negative electrode layers, cellulose separators 24 of the buffer layers, and gasket sheets 25 are created in predetermined sizes and one gasket sheet 25 each is pasted to the two pieces of solid electrolyte 23, where the isolation layers, negative electrode layers, buffer layers, and gasket sheets 25 are components of the negative electrode complex 20.
(2) The cellulose separator 24 is placed on the first piece of the solid electrolyte 23 in such a way as to fit in the frame of the gasket sheet 25 and an organic electrolyte is dripped onto a cellulose separator 24 and allowed to seep into the entire cellulose separator 24. The metallic lithium 22 is placed on the cellulose separator 24 in such a way as to fit in the frame of the gasket sheet 25 and the second cellulose separator 24 is placed on the metallic lithium 22. Subsequently, the organic electrolyte is dripped onto the second cellulose separator 24 and is allowed to seep into the entire cellulose separator 24, and the cellulose separator 24 and metallic lithium 22 are brought into intimate contact with each other.
(3) The second piece of the solid electrolyte 23 is put on the product of step (2) without displacement such that the gasket sheet 25 pasted on the second piece of the solid electrolyte 23 and the gasket sheet 25 pasted on the first piece of the solid electrolyte 23 will be superposed one on top of the other. The two gasket sheets 25 are stuck together, and sealed by the adhesiveness of the gasket sheets 25 to keep out outside air. The entire assembly is pressed down and fixed from outside so that the components in the negative electrode complex 20, especially the solid electrolyte 23 and metallic lithium 22, will come into contact with each other, achieving good adhesion. Also, part of the copper foil (negative electrode collector 21) pasted on the metallic lithium 22 is exposed outside the solid electrolyte 23.
(4) The epoxy adhesive 26 is applied thinly to entire outer peripheral edges of the solid electrolyte 23, sealing a space between the two pieces of the solid electrolyte 23, and the epoxy adhesive 26 is allowed to set.

Next, an example of procedures for creating the positive electrode material will be described.

The positive electrode material is created using procedures (1) to (4) below.

(1) 80 mg of carbon-supported platinum (Pt: 45.8%) and 20 mg of polyvinylidene fluoride (PVDF) are measured out as a catalyst for oxygen reduction of the positive electrode material and as a binder, respectively, and a mixed solvent is prepared by adding 3.0 mL of n-methyl pyrrolidone (NMP).
(2) Positive electrode material with an amount of supported platinum of approximately 0.25 mg/cm² is created as follows: the mixed solvent is stirred and dispersed by a mixer (AR-100 made by Thinky) for 15 minutes, and by ultrasound for 60 minutes, the mixed solvent is applied to carbon cloth using a coating machine (control coater K202 made by Matsuo Sangyo), and then the carbon cloth is placed on a hot plate and dried at 110° C. for one hour.
(3) The positive electrode material produced in step (2) is cut to the size of the metallic lithium 22 of the negative electrode complex 20 in order to match the size (area) of the carbon cloth which supports platinum with the size of the metallic lithium 22.
(4) A desired number of pieces (3 pieces, 4 pieces) of the positive electrode material 32 cut to the size of the metallic lithium 22 of the negative electrode complex 20 are stacked one on top of another by being sewn with a carbon fiber thread.

Next, an example of preparation of an aqueous electrolyte will be described.

2 M (mol/L) of LiCl water solution is prepared by dissolving 4.24 g of LiCl in purified water 500 mL To hold the aqueous electrolyte, the aqueous electrolyte is dripped onto a cellulose sheet and the cellulose sheet is placed between the positive electrode structure 30 and negative electrode complex 20.

Next, a discharge test conducted using the negative electrode complex 20, positive electrode material 32, and the like produced by the above procedures will be described.

The metal-air battery according to the present embodiment includes the positive electrode structure 30 produced by applying a catalyst to the positive electrode material 32 such as carbon cloth to facilitate an oxygen reduction reaction during discharge. The metal-air battery uses oxygen in the air as an active material of the positive electrode. Therefore, to improve discharge characteristics by facilitating oxygen reduction, it is necessary to increase oxygen permeability by increasing the specific surface area of the catalyst.

In the positive electrode structure 30 according to the present embodiment, since pieces of the positive electrode material 32 thinly coated with the catalyst are stacked one on top of another as shown in FIG. 1, the active specific surface area of the catalyst increases, facilitating discharge. The positive electrode structure 30 in this example, mitigates, in particular, the fall in discharge voltage occurring when, for example, the battery capacity is increased from 80-mAh cells to 400-mAh cells, enabling long hours of discharge. That is, the discharge capacity of the battery can be increased.

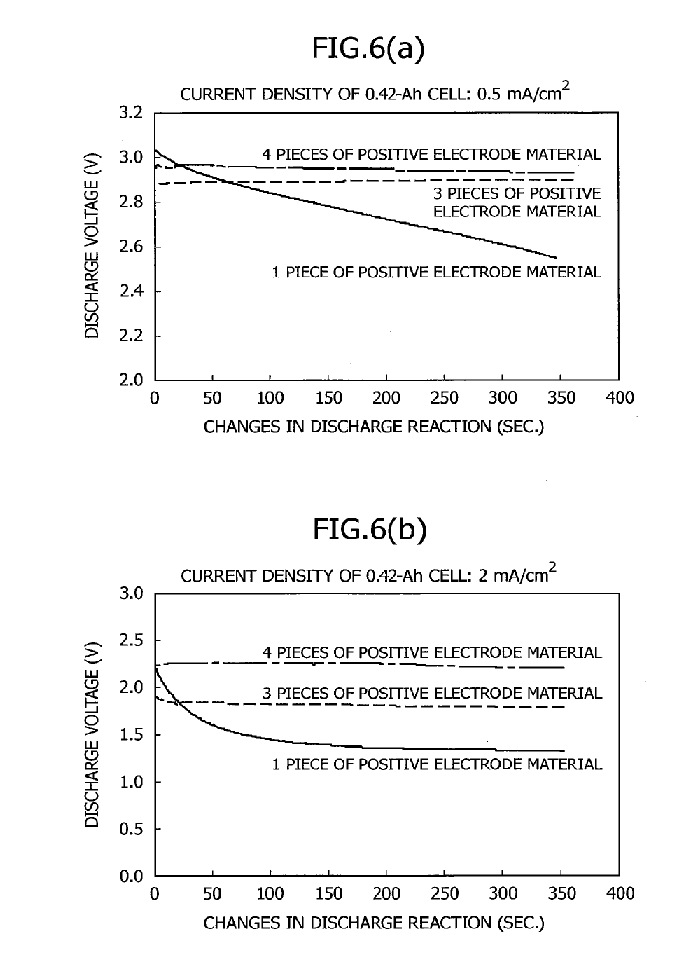

FIGS. 6A and 6B are graphs showing discharge characteristics versus current density and the number of pieces of the positive electrode material 32 in the positive electrode structure according to the present embodiment. FIG. 6A shows a discharge voltage when the number of pieces of the positive electrode material is one, three, or four and the current density is 0.5 mA/cm² on a negative electrode complex of which the theoretical capacity is 0.42 Ah. FIG. 6B shows a discharge voltage when the number of pieces of the positive electrode material is one, three, or four and current density is 2 mA/cm² on a negative electrode complex of which the theoretical capacity is 0.42 Ah.

When the current density in FIG. 6A is low (0.5 mA/cm²), since the oxygen reducing ability in the positive electrode does not need to be high, even if the number of pieces is increased, increases in the discharge voltage are small. The increase is small especially when the number of pieces is changed from three to four.

In contrast, the configuration according to the present embodiment is effective when the current density is higher than 0.5 mA/cm², for example, when the current density is 2 mA/cm² as shown in FIG. 6B. Compared to when there is one piece of positive electrode material, when there are three or four pieces, since the specific surface area of the catalyst increases, facilitating oxygen reduction and thereby improving discharge characteristics, the discharge voltage does not fall even if a large electric current is passed. Compared to when the current density is low (0.5 mA/cm²) as shown in FIG. 6A, when the current density is high (2 mA/cm²) as shown in FIG. 6B, the increase is large when the number of pieces is changed from three to four.

The description of the above embodiment is illustrative in describing the present invention and is not intended to limit the claimed invention. Also, various components of the present invention are not limited by the above embodiment and various modifications are possible within the technical scope of the appended claims.

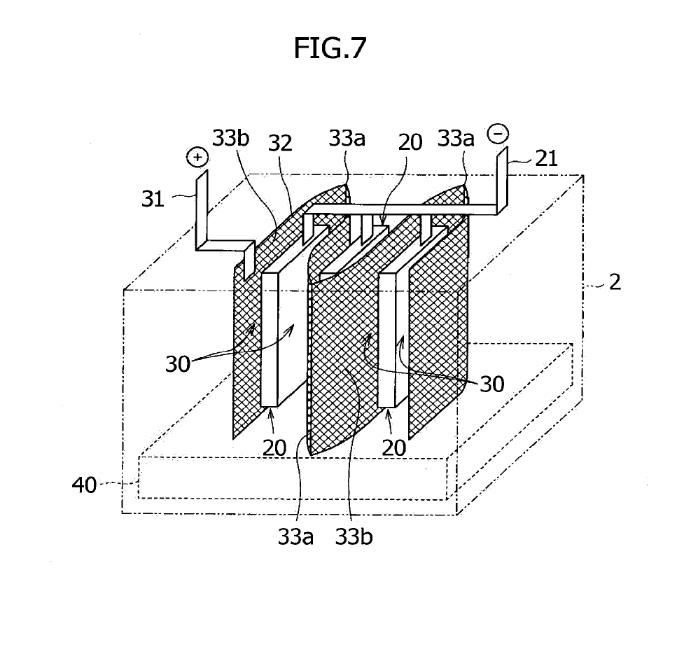

A variation of FIG. 3 will be described with reference to FIG. 7. As shown in FIG. 7, the positive electrode material 32 may be a single plate-like member bent in a zigzag pattern. In this case, the plural negative electrode complexes 20 are each sandwiched by a pair of planar portions 33b provided between folds 33a of the positive electrode material 32. With this configuration, only a single positive electrode collector 31 can be provided for one air electrode layer which sandwiches the plural negative electrode complexes 20, making it possible to reduce quantity, total length, length, weight and volume.

### REFERENCE SIGNS LIST

1 Metal-air battery
2 Case
11 Metal-air battery cell
20 Negative electrode complex
21 Negative electrode collector (copper foil)
22 Negative electrode layer (metallic lithium)
23 Isolation layer (solid electrolyte)
24 Buffer layer (cellulose separator)
25 Gasket sheet
26 Joining portion (epoxy adhesive)
30 Positive electrode structure
31 Positive electrode collector
32 Positive electrode material
33a Fold
33b Planar portion
34 Oxygen reaction layer
40 Electrolyte

1. A metal-air battery in which respective substantially flat surfaces of a positive electrode and negative electrode are stacked on each other, extending substantially perpendicularly with respect to a horizontal direction, and ions are transmitted between the positive electrode and the negative electrode through an electrolyte placed between the positive electrode and the negative electrode, wherein:
the positive electrode includes a plurality of plate-shaped pieces of positive electrode material having a porosity structure or fibrous structure and containing an electrically conductive material;
the positive electrode material is electrically connected with a plate-like or linear, positive electrode collector;
surfaces of the plurality of pieces of the positive electrode material are coated with a catalyst;
the plurality of pieces of the positive electrode material are stacked with the catalyst-coated surfaces facing each other; and
a direction in which the plurality of pieces of the positive electrode material are stacked is arranged to be parallel to a direction in which the positive electrode and negative electrode are stacked.

2. The metal-air battery according to claim 1, wherein: the catalyst coats surfaces of the porous structure or the fibrous structure; and the porous structure or the fibrous structure is configured to allow air to circulate therein.

3. The metal-air battery according to claim 1 or 2, wherein from 0.19 mg/cm² to 0.75 mg/cm², both inclusive, of a mixture containing the catalyst is supported by the positive electrode material.

4. The metal-air battery according to claim 1, wherein from 0.15 mg/cm² to 0.60 mg/cm², both inclusive, of the catalyst is supported by the positive electrode material.

5. The metal-air battery according to claim 1, wherein the positive electrode material is formed of carbon paper, carbon cloth, or carbon fiber nonwoven fabric.

6. The metal-air battery according to claim 1, wherein an oxygen reaction layer is formed between adjacent pieces of the positive electrode material.

7. The metal-air battery according to claim 1, wherein the negative electrode is a complex negative polar body produced by stacking a plate-like or rod-shaped negative electrode collector, a plate-like negative electrode layer, and an isolation layer;
wherein the negative electrode layer is made of metallic lithium, an alloy of which the principal component is lithium, or a compound of which the principal component is lithium, and the isolation layer has lithium ion conductivity.

8. The metal-air battery according to claim 7, wherein:
the complex negative polar body includes a plate-like or rod-shaped negative electrode collector, two negative electrode layers made of metallic lithium, an alloy of which the principal component is lithium, or a compound of which the principal component is lithium and formed into plate shapes so as to sandwich part of the negative electrode collector, two isolation layers provided with lithium ion conductivity and formed into plate shapes so as to entirely sandwich the two negative electrode layers, and a joining portion adapted to join and close outer peripheral portions of the two isolation layer; and
the positive electrode material is electrically connected to the positive electrode collector, facing at least one of the two isolation layers.

9. The metal-air battery according to claim 7, wherein the negative electrode complex and positive electrode material are stacked alternately and electrically connected in parallel.

10. The metal-air battery according to claim 8, wherein
the positive electrode material is bent in a zigzag pattern, and
a plurality of negative electrode complexes are sandwiched by planar portions provided between folds of the positive electrode material.

11. The metal-air battery according to claim 8, comprising a gasket placed between the two isolation layers, surrounding the two negative electrode layers, and adapted to seal a space between the two isolation layers.
